(19) United States
(12) Patent Application Publication
(10) Pub. No.: US 2012/0243876 A1
(43) Pub. Date: Sep. 27, 2012

(54) USE OF SEMICONDUCTOR OPTICAL AMPLIFIERS-BASED INTENSITY MODULATOR IN SIGNAL TRANSMISSION

(75) Inventor: Jianming Tang, Harlow Essex (GB)

(73) Assignee: Bangor University, Bangor Gwynedd (GB)

(21) Appl. No.: 13/504,689

(22) PCT Filed: Oct. 29, 2010
(86) PCT No.: PCT/EP2010/066467

§ 371 Date: May 24, 2012

(30) Foreign Application Priority Data
Oct. 30, 2009 (GB) 0919039.8

(51) Int. Cl. H04B 1/40; H04B 10/00

(52) U.S. Cl. 398/135

(57) ABSTRACT

The present invention discloses the use of a semiconductor optical amplifier in a transceiver in order to increase the number of end users without reducing the bandwidth allocated to each user.

### BACKGROUND OF THE INVENTION

1. Field of the Invention

The present invention relates to the field of colourless signal transmission using optical orthogonal frequency division multiplexing (OOFDM) transceivers, to the use of semiconductor optical amplifiers in order to allocate proper dynamic bandwidth to each user.

2. Description of the Related Art

It is known to use the optical orthogonal frequency division multiplexing (OOFDM) technique in order to reduce optical modal dispersion in multimode fibre (MMF) transmission links, as disclosed for example in Jolley et al. (N. E. Jolley, H. Kee, R. Richard, J. Tang, K. Cordina, presented at the National Fibre Optical Fibre Engineers Conf., Annaheim, Calif., Mar. 11, 2005, Paper OFP3). It offers the advantages of great resistance to dispersion impairments, efficient use of channel spectral characteristics, cost-effectiveness due to full use of mature digital signal processing (DSP), dynamic provision of hybrid bandwidth allocation in both the frequency and time domains, and significant reduction in optical network complexity.

It can also be used advantageously for dispersion compensation and spectral efficiency in single mode fibre (SMF)-based long distance transmission systems such as described for example by Lowery et al. (A. J. Lowery, L. Du, J. Armstrong, presented at the National Fibre Optical Fibre Engineers Conf., Annaheim, Calif., Mar. 5, 2006, paper PDP39) or by Djordjevic and Vasic (I. B. Djordjevic and B. Vasic, in Opt. express, 14, no. 9, 37673775, 2006).

The transmission performances of OOFDM have been studied and reported for all the optical network scenarios including long-haul systems such as described for example in Masuda et al. (H. Masuda, E. Yamazaki, A. Sano, T. Yoshimatsu, T. Kobayashi, E. Yoshida, Y. Miyamoto, S. Matsuoka, Y. Takatori, M. Mizoguchi, K. Okada, K. Hagimoto, T. Yamada, and S. Kamei, “13.5-Tb/s (135×111-Gb/s/ch) no-guard-interval coherent OFDM transmission over 6248 km using SNR maximized second-order DRA in the extended L-band,” Optical Fibre Communication/National Fibre Optic Engineers Conference (OFC/NFOEC), (OSA, 2009), Paper PDPB5) or in Schmidt et al. (B. J. C. Schmidt, Z. Zan, L. B. Du, and A. J. Lowery, “100 Gbit/s transmission using single-band direct-detection optical OFDM,” Optical Fibre Communication/National Fibre Optic Engineers Conference (OFC/NFOEC), (OSA, 2009), Paper PDPC3) or metropolitan area networks such as described for example in Duong et al. (T. Duong, N. Genay, P. Chanclou, B. Charbonnier, A. Pizzinat, and R. Brenot, “Experimental demonstration of 10 Gbit/s for upstream transmission by remote modulation of 1 GHz RSOA using Adaptively Modulated Optical OFDM for WDM-PON single fiber architecture,” European Conference on Optical Communication (ECOC), (Brussels, Belgium, 2008), PD paper Th.3.F.1) or in Chow et al. (C.-W. Chow, C.-H. Yeh, C.-H. Wang, F.-Y. Shih, C.-L. Pan and S. Chi, “WDM extended reach passive optical networks using OFDM-QAM,” Optics Express, 16, 12096-12101, July 2008), or access and local area networks such as described for example in Qian et al. (D. Qian, N. Cvijetic, J. Hu, and T. Wang, “108 Gb/s OFDMA-PON with polarization multiplexing and direct-detection,” Optical Fibre Communication/National Fibre Optic Engineers Conference (OFC/NFOEC), (OSA, 2009), Paper PDPD5) or in Yang et al. (H. Yang, S. C. J. Lee, E. Tangdiongga, F. Breyer, S. Randel, and A. M. J. Koonen, “40-Gb/s transmission over 100 m graded-index plastic optical fibre based on discrete multitone modulation,” Optical Fibre Communication/National Fibre Optic Engineers Conference (OFC/NFOEC), (OSA, 2009), Paper PDPD8).

All prior art existing systems were based on transmission of OOFDM signals originating from arbitrary waveform generators (AWG) using off-line signal processing-generated waveforms. At the receiver, the transmitted OOFDM signals were captured by digital storage oscilloscopes (DSO) and the captured OOFDM symbols were then processed off-line to recover the received data. Such off-line DSP approaches did not consider the limitations imposed by the precision and speed of practical DSP hardware that are required for insuring real-time OOFDM transmission.

It has been improved by introducing the signal modulation technique known as adaptively modulated optical OFDM (AMOOFDM), offering advantages such as:
Improved system flexibility and compatibility, performance robustness, and transmission performance;
efficient use of spectral characteristics of transmission links and adaptive compensation of imperfect system and network components; individual subcarrier power and bits within an OFDM symbol can be modified according to needs in the frequency domain;
use of existing network infrastructure;
low installation and maintenance cost.

These have been described and discussed for example in Tang et al. (J. Tang, P. M. Lane and K. A. Shore in IEEE Photon. Technol. Lett, 18, no. 1, 205-207, 2006 and in J. Lightw. Technol., 24, no. 1, 429-441, 2006) or in Tang and Shore (J. Tang and K. A. Shore, in J. Lightw. Technol., 24, no. 6, 2318-2327, 2006). Additional aspects such as
the impact of signal quantisation and clipping effects related to analogue to digital conversion (ADC) and determination of optimal ADC parameters;
maximisation of the transmission performance by optimising the ADC/DAC parameters;
   have been described in Tang and Shore (J. Tang and K. A. Shore, in J. Lightw. Technol., 25, no. 3, 787-798, 2007).

In order to implement real-time OOFDM transceivers, there is a need to develop advanced high-speed signal processing algorithms with less complexity to achieve a wide range of key functionalities including IFFT/FFT, channel estimation and equalisation, system synchronisation, on-line performance monitoring and live parameter optimisations.

### SUMMARY OF THE INVENTION

It is an objective of the invention to double the capacity of transmission using OOFDM transceivers with various real-time DSP algorithms and on-line performance monitoring and live parameter optimisation.

It is also an objective of the present invention to ensure input/output reconfigurability.

It is another objective of the present invention to allocate proper dynamic bandwidth to each user.

It is yet another objective of the present invention to provide a colourless transmission.

It is a further objective of the present invention to reduce the installation and maintenance costs both in time and money.

It is yet a further aim of the present invention to increase the total number of end-users.

In accordance with the present invention, the foregoing objectives are realised as defined in the independent claims. Preferred embodiments are defined in the dependent claims.

### BRIEF DESCRIPTION OF THE DRAWINGS

FIG. 1 is a schematic representation of the OOFDM transceiver of the present invention

FIG. 2 represents the detailed real-time OOFDM transceiver architectures.

FIG. 3 represents the signal line rate expressed in Gb/s as a function of continuous-wave (CW) wavelength expressed in nm for different optical input powers and for a bias current of 100 mA, a peak-to-peak value of the driving current of 80 mA and a transmission distance of 60 km.

FIG. 4 represents the maximum achievable AMOOFDM transmission capacity expressed in Gb/s versus transmission distance expressed in km for optimum operating conditions at different CW wavelengths.

FIG. 5 represents contour plots of signal line rate expressed in Gb/s as a function of both optical input power expressed in dBm and bias current expressed in mA for a wavelength of 1510 nm and for a transmission distance of 60 km and for a driving current with a constant peak-to-peak value of 80 mA.

FIG. 6 represents contour plots of signal line rate as a function of both optical input power expressed in dBm and bias current expressed in mA for a wavelength of 1550 nm and for a transmission distance of 60 km and for a driving current with a constant peak-to-peak value of 80 mA.

FIG. 7 represents contour plots of signal line rate as a function of both optical input power expressed in dBm and bias current expressed in mA for a wavelength of 1590 nm and for a transmission distance of 60 km and for a driving current with a constant peak-to-peak value of 80 mA.

FIG. 8 represents signal line rate expressed in Gb/s versus peak-to-peak value of driving current expressed in mA for different CW wavelengths.

### DESCRIPTION OF THE PREFERRED EMBODIMENTS

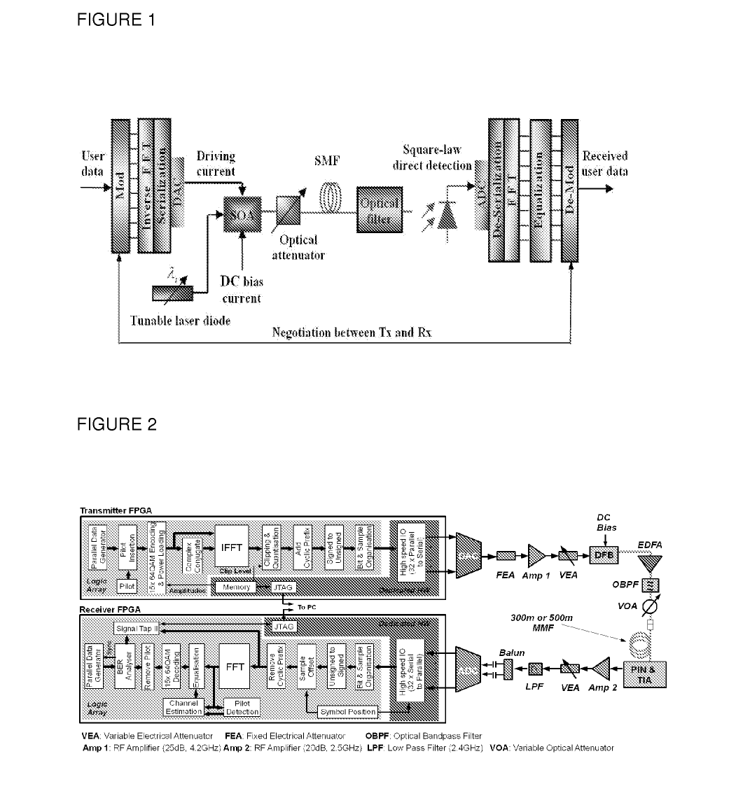

Accordingly, the present invention discloses an OOFDM transceiver, as represented in FIG. 1 and FIG. 2 that comprises:
a) a field-propammable gate array (FPGA)
b) a digital to analogue converter (DAC);
c) a semiconductor optical amplifier (SOA) system that consists of
   i) a tunable laser diode;
   ii) a DC bias current; and
   iii) a SOA
d) optionally, an optical attenuator;
e) a single or multiple mode fibre or a polymer optical fibre;
f) optionally, an optical filter,
g) a receiver

The field-programmable gate array (FPGA) is a semiconductor device that can be configured as required by the end-user. It is programmed using a logic circuit diagram or a source code in a hardware description language (HDL) to specify how the chip will work. It is used to implement any logical function that an application-specific integrated circuit (ASIC) could perform and it further has the ability to update the functionality. It contains programmable logic components and a hierarchy of reconfigurable interconnects that allow the blocks to be “wired together”. Logic blocks can be configured to perform complex combinational functions and they include memory elements.

In the present invention the FPGA is programmed for performing the operations of:
i) encoding the incoming binary data sequence into serial complex numbers using different signal modulation formats;
ii) truncating the encoded complex data sequence into a number of equally spaced narrow band data;
iii) data buffering
iv) bus-width conversion
v) applying an inverse time to frequency domain transform such as an inverse fast Fourier transform (IFFT) for generating parallel complex OOFDM symbols;
vi) inserting a prefix in front of each symbol of step v) said prefix being a copy of the end portion of the symbol;
vii) serialising the parallel symbols into a long digital sequence
viii) channel estimation and equalisation
ix) system synchronisation
x) on-line monitoring
xi) live parameter optimisation

In a most preferred embodiment according to the present invention, the semiconductor optical amplifier is placed in a transceiver wherein the transmitter doubles the transmission capacity of an optical orthogonal frequency division multiplexing (OOFDM) transceiver by using both the real and imaginary parts of the inverse fast Fourier transform to convey information related respectively to signal A and to signal B. This double capacity transmitter is disclosed in detail in a co-pending application GB0919047.1, filed on the same date as the present application. It comprises the steps of;
a) encoding the incoming binary data sequence into serial complex numbers using different signal modulation formats;
b) applying a serial to parallel converter to the encoded complex data;
c) generating a sum of two individual sets of 2N parallel data, {A} and {B} wherein {A} and {B} satisfy the relationships A_{2N-n}=A*ₙ and B_{2N-n}=B*ₙ for n ranging from 1 to 2N−1, A* and B* being respectively the complex conjugates of A and B, and wherein {A} and {B} also satisfy the relationships Im{A₀}=Im{A_{N}}=Im{B₀}=Im{B_{N}}=0
d) applying the inverse of a time to frequency domain transform, to the sum of the 2 sets of sub-carriers using field programmable gate array (FPGA)-based transform logic function algorithms in order to generate parallel complex OFDM symbols wherein the k-th symbol can be expressed as

$${S}_{k}^{A + B} ( t ) = {\sum }_{n = 0 to 2 N - 1}^{ } {A}_{k} exp ( i 2 Π n Δ f t ) + {\sum }_{n = 0 to 2 N - 1}^{ } {B}_{k} exp ( i 2 Π n Δ f t ) \\ = {I}_{k\_A} ( t ) + {iQ}_{k\_B} ( t )$$

wherein Δf is the frequency spacing between adjacent subcarriers and wherein I and Q represent respectively the in-phase component and the quadrature component;
e) inserting a prefix in front of each symbol of step d), said prefix being a copy of the end portion of the symbol;
f) serialising these symbols in order to produce a long digital sequence;
g) applying two digital to analogue converters to convert the real and imaginary parts of the digital sequence into analogue waveforms;
h) passing each of said g) analogue waveforms through a separate semiconductor amplifier system to generate an optical waveform at different wavelength;
i) optionally, passing through an optical attenuator;
j) coupling the optical signal into a single mode fibre (SMF) or multimode fibre (MMF) or polymer optical fibre (POF) link;
k) optionally, applying an optical filter
   said method being characterised in that, in the transmitter, two complex signals Aₖ and Bₖ are input into the inverse transform
   and wherein the in-phase component of the inverse transform output contains information from A alone and the quadrature component contains information from B alone.

The signal modulation formats are those typically used in the field and are described for example in Tang et al. (Tang J. M., Lane P. M., Shore A., in Journal of Lightwave Technology, 24, 429, 2006.). The signal modulation formats vary from differential binary phase shift keying (DBPSK), differential quadrature phase shift keying (DQPSK) and 2^{p} quadratic amplitude modulation (QAM) wherein p ranges between 3 and 8, preferably between 4 and 6. The information is thus compressed thereby allowing reduction of the bandwidth.

The serial to parallel converter truncates the encoded complex data sequence into a large number of sets of closely and equally spaced narrow-band data, the sub-carriers, wherein each set contains the same number of sub-carriers 2N wherein N ranges between 8 and 256.

Discrete or fast Fourier transforms (DFT or FFT) are typically used in the field. Preferably FFT is used as it reduces significantly the computational complexity, which however remains very computationally demanding. 2^{p} point IFFT/FFT logic function wherein p is an integer ranging from 4 to 8, is preferably used in the present invention.

The analogue to digital converter (ADC) is an electronic device that converts a continuous analogue signal to a flow of digital values proportional to the magnitude of the incoming signal.

The tunable semiconductor laser diode provides a continuous wave light source having a power of at most 10 dBm and selected wavelength windows. In the present invention the selected wavelength windows are at 850 nm, 1300 nm and 1550 nm.

The bias current is adjusted to provide together with the driving current emerging from the digital to analogue converter optimal operating conditions for the semiconductor optical amplifier. The bias current is preferably as small as possible and is of at most 100 mA or the optical power ranges between −10 and +20 dBm, preferably it is about 0 dBm.

An optical amplifier is a device that amplifies an optical signal without converting it first to an electrical signal. Incoming light is amplified by stimulated emission in the amplifier's gain medium. In semiconductor optical amplifiers, the gain medium is provided by a semiconductor. They have a structure similar to that of Fabry-Perot laser diodes but they additionally include anti-reflection design elements at the endfaces. Endface reflection can de reduced to less than 0.001% by including anti-reflective coatings and/or tilted waveguide and/or window regions. In such structure, the loss of power from the cavity is greater than the gain, thereby preventing the amplifier from acting as a laser.

They are typically prepared from compounds including metals Group 13 to 15 of the periodic Table such as for example GaAs/AlGaAs, InP/InGaAs, InP/InGaAsP and InP/InAlGaAs. They typically operate at signal wavelengths between 0.85 μm and 1.6 μm and generate gains of up to 30 dB.

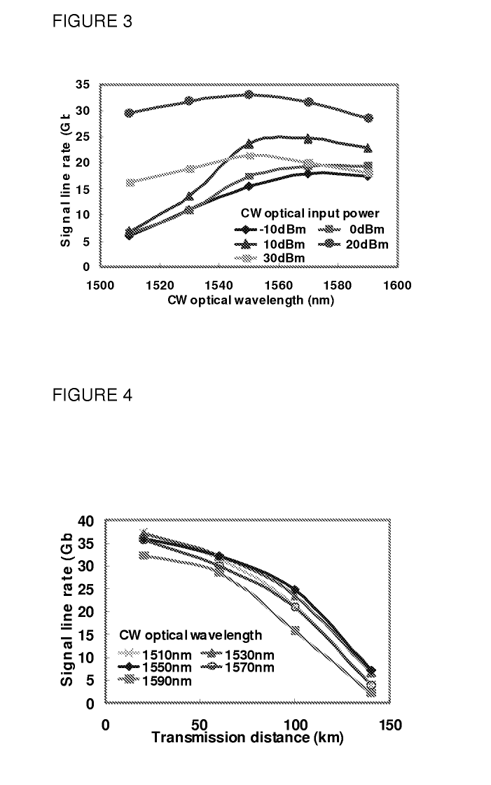

The operating conditions of the SOA need to be optimised in order to reduce the wavelength dependence of AMOOFDM transmission performance. Said dependence before optimisation is shown in FIG. 3 for a bias current of 100 mA, a peak-to-peak value of the driving current of 80 mA and a transmission distance of 60 km. FIG. 3 shows that, under the SOA operating conditions specified above, the AMOOFDM transmission performance depends strongly upon the wavelength and power of the input optical signal. For optical input powers of at most 10 dBm, the signal line rate grows rapidly with increasing CW wavelength up to a wavelength of 1570 nm. The curve then flattens with further increase in wavelength. On the other hand, for optical input powers larger than 10 dBm, the signal capacity differences for different CW wavelengths are reduced considerably, and an almost symmetrical signal capacity occurs with respect to a CW wavelength of about 1550 nm. In addition, for a fixed CW wavelength, the signal line rate increases with increasing optical input power for optical input powers of less than 20 dBm, beyond this value, the achievable signal line rate drops sharply.

Optimisation of SOA operating conditions enables the production of AMOOFDM transmitters that no longer depend upon wavelength and are thus “colourless”. This is carried out by adjusting the bias current.

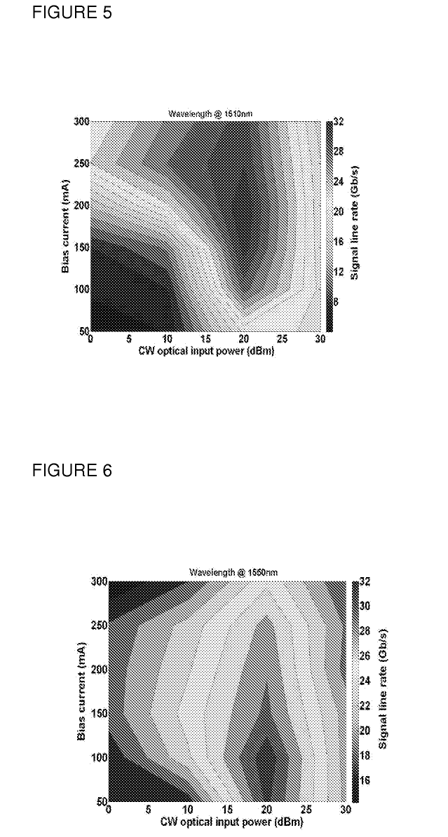

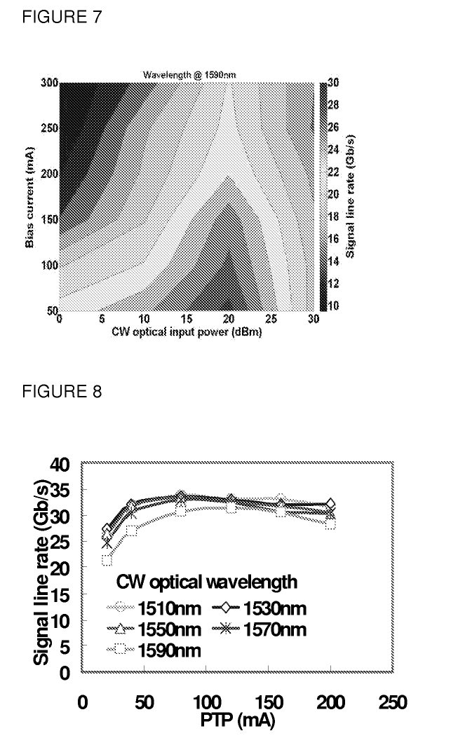

The optimum SOA operating conditions are wavelength dependent. When CW wavelength increases, the optimum SOA bias current decreases and the optimum optical input power and peak-to-peak power of the driving current remain almost unchanged. The optimum optical input power is required to be wavelength independent. The optimum bias current necessary to achieve this result increases with decreasing wavelength. For a wavelength of 1550 nm, the bias current is of the order of 100 mA, for a wavelength of 1510 nm is of the order of 200 mA and for a wavelength of 1590 nm, it is of the order of 50 mA, as can be seen on FIGS. 5, 6 and 7.

At the output of the SOA intensity modulator, the power and phase of the modulated optical signal at time t can be written as

Pₒᵤₜ(t)=Pᵢₙ(t)exp[h(t)]

φₒᵤₜ(t)=φᵢₙ(t)−½αh(t)

wherein Pₒᵤₜ and φₒᵤₜ are respectively the power and the phase of the optical output signal, whereas Pᵢₙ and φᵢₙ are the power and phase of the optical input signal. h is the integrated SOA optical gain and α is the linewidth enhancement factor. The linear relationship between the input and output of the optical signals indicates that an extra broadcasting signal and/or a signal undertaking pre-compensation of link spectral distortions can be modulated onto the input optical signal without affecting the transmission performance of the SOA intensity modulators.

Alternatively, quantum dot SOA (QD-SOA) can be used. Their use reduces the optimum CW optical power to a level as low as 0 dBm without affecting the transmission performance which remains equivalent to that of conventional SOAs. A small optical power is very desirable as the technique is easier to achieve in practice and more economical.

The optical attenuator reduces the power level in the optical fibre. It can either use the gap loss principle when placed close to the transmitting end or it may use absorptive or reflective techniques.

The optical fibres used in the present invention can be selected from single mode, multimode or polymer optical fibres.

Single mode optical fibres (SMF) are designed to carry only a single ray of light. They do not exhibit modal dispersion resulting from multiple spatial modes and thus retain the fidelity of each light pulse over long distances. They are characterised by a high bandwidth. They can span tens of kilometers at 1 Tb/s.

Multimode optical fibres (MMF) are mostly used for communication over shorter distances. Typical multimode links have data rates of 10 Mb/s to 10 Gb/s over link lengths of up to 600 metres. They have a higher light gathering capacity than SMF but their limit on speed times distance is lower than that of SMF. They have a larger core size than SMF and can thus support more than one propagation mode. They are however limited by modal dispersion, resulting in higher pulse spreading rates than SMF thereby limiting their information transmission capacity. They are described by their core and cladding diameters.

Polymer optical fibres (POF) are made of plastic such polymethylmethacrylate (PMMA) or perfluoribated polymers for the core and fluorinated polymers for the cladding. In large-diameter fibres, the core, allowing light transmission, represents 96% of the cross section. Their key features are cost efficiency and high resistance to bending loss.

Optical filters are used to clean up the signal and reduce the SOA-induced noise.

FIG. 4 represents the maximum achievable AMOOFDM transmission capacity versus transmission distance for optimum operating conditions at various CW wavelengths. Within a broad wavelength region of 1510-1590 nm, an almost wavelength insensitive AMOOFDM transmission performance can be obtained for transmission distances of up to 150 km. In particular, SOA-enabled colourless transmitters are capable of supporting signal transmission larger than 30 Gb/s over distances of 60 km with single mode fibres (SMF). It should be pointed out that the worst transmission performance at 1590 nm is mainly due to the long wavelength-induced strong chromatic dispersion effect. The transmission performance of the colourless transmitters is also very robust to variations in SOA parameters such as saturation energy and SOA length.

Multimode fibre can also be used to support signal transmission larger than 30 Gb/s over distances of larger than 300 m.

Because the transmission system is colourless or wavelength independent, it is able to transmit several wavelengths and each user is thus part of a multi-wavelength arrangement. The number of end users can thus be increased while maintaining the same bandwidth. The working bandwidth is from 1530 to 1590 nm.

### EXAMPLES

### Determination of Optimal SOA Operating Conditions

Optimum SOA operating conditions for different CW optical wavelengths are shown in FIGS. 5, 6 and 7 representing respectively contour plots of signal line rate as a function of both optical input power and bias current for wavelengths of 1510 nm, 1530 nm and 1590 nm and for a transmission distance of 60 km and a driving current with a constant peak-to-peak value of 80 mA. It shows that, for a specific wavelength, there exists an optimum bias current and an optimum optical input power, corresponding to which a maximum signal line rate is obtained. The optimum SOA operating conditions are wavelength dependent. When CW wavelength increases, the optimum SOA bias current decreases and the optimum optical input power remains almost unchanged. For example, at a wavelength of 1510 nm, the optimum bias current and the optimum optical input power are approximately 200 mA and 20 dBm, respectively whereas at a wavelength of 1590 nm the values of these two parameters are approximately 50 mA and 20 dBm. In particular, when SOA is operated at optimum operating conditions corresponding to different wavelengths, a variation in maximum achievable signal line rate of less than 3 Gb/s is obtained across an entire wavelength range of 80 nm. Colourless AMOOFDM transmitters are therefore obtained when optimum SOA operating conditions are selected according to the selected CW wavelength.

### Determination of Maximum Transmission Performance.

The impact of driving current peak-to-peak (PTP) on the maximum achievable AMOOFDM transmission performance can be seen in FIG. 8 for different wavelengths. The optimum optical input power and bias current are determined for each individual wavelength selected. The transmission distance is taken to be 60 km. It can be seen that the optimum PTP value is of about 80 mA for CW wavelengths varying between 1510 nm and 1590 nm.

1. An OOFDM transceiver that comprises:
a) a field-programmable gate array (FPGA)
b) a digital to analogue converter (DAC);
c) a semiconductor optical amplifier (SOA) system that consists of
i) a tuneable semiconductor laser diode providing a continuous wave (CW) light source having a power of at most 10 dBm, and selected wavelength windows;
ii) a DC bias current; and
iii) a SOA
d) an optical attenuator;
e) a single or multiple mode fibre or a polymer optical fibre; and
f) a receiver.

2. The OOFDM transceiver of claim 1 wherein the FPGA is designed to perform the operations of:
a) encoding the incoming binary data sequence into serial complex numbers using different signal modulation formats/adaptive subcarrier power loading;
b) truncating the encoded complex data sequence into a number of equally spaced narrow band data;
c) data buffering
d) bus-width conversion;
e) applying an inverse time to frequency domain transform such as an inverse fast Fourier transform (IFFT) for generating parallel complex OOFDM symbols;
f) inserting a prefix in front of each symbol of step e) said prefix being a copy of the end portion of the symbol;
g) serializing the parallel symbols into a long digital sequence;
h) channel estimation and equalization;
i) system synchronization;
j) on-line monitoring; and
k) live parameter optimization functions.

3. The OOFDM transceiver of claim 1 wherein the DC bias current is selected to optimize the operating conditions of the SOA and is of at most 100 mA.

4. The OOFDM transceiver of claim 1 wherein the tuneable semiconductor laser diode has selected wavelength windows centered at 850 nm, 1300 nm and 1550 nm.

5. The OOFDM transceiver of claim 1 wherein SOA conditions are optimized by decreasing the bias current with increasing CW wavelength.

6. Use of the SOA in the transceiver, operated under the optimized conditions of claim 3, to provide colorless transmission.

7. Use of the SOA according to claim 6 in a transceiver wherein two individual symbol synchronization schemes are utilized for two signals of different wavelengths, which correspond to the real and imaginary parts of an inverse fast Fourier transform in the transmitter and convey information related to these two signals.

8. Use according to claim 6 wherein the number of end users and the bandwidth for each user are increased with respect to conventional systems which use DFB lasers.

9. The OOFDM transceiver of claim 1, further comprising:
a) an optical filter.
